(19) United States
(12) Patent Application Publication
(10) Pub. No.: US 2011/0210685 A1
(43) Pub. Date: Sep. 1, 2011

(54) LIGHTED HAT WITH A POWER SUPPLY DEVICE AS FLASHLIGHT

(76) Inventor: Sung-Yie Liao, Taichung (TW)

(21) Appl. No.: 12/713,882

(22) Filed: Feb. 26, 2010

(51) Int. Cl. H05B 39/00

(52) U.S. Cl. 315/313; 362/106

(57) ABSTRACT

A lighted hat includes a hat unit comprising a crown including a pocket on one side, a visor, and an adjuster; a light assembly on the hat unit; and a removable power supply device in the pocket and comprising a rechargeable battery and a control assembly including a push button switch, a slide switch for switching the power supply device to a flashlight or illumination mode, and a light emitting member. In the flashlight mode, a pressing of the push button switch causes the light emitting member to electrically connect to the battery for light emission, and a next pressing of the push button switch causes the light emitting member to electrically disconnect from the battery. In the illumination mode, the light assembly is electrically connect to the battery such that a pressing of the push button switch cause the light assembly to emit light, blink, or turn off.

### BACKGROUND OF THE INVENTION

1. Field of Invention

The invention relates to lighted hats and more particularly to a lighted hat having a power supply device adapted to be a flashlight.

2. Description of Related Art

Hats are commonly used, and a wide variety of hats are available. Conventionally, a person may wear a hat for shading or shielding the eyes from the sun, rain, or for decoration purposes. Recently, lighted hats have been developed. One function of such lighted hats is for illumination only so that a wearer may have spare hands to do things in a dark environment.

However, light emitted by such hats is not directional and only serves as warning purpose as it is not bright enough. Hence, its illumination is less than that of a flashlight. Therefore, people always hold a flashlight by one hand and hold a tool by the other hand to do various tasks in a dark environment. This is inconvenient. Thus, the need for improvement still exists.

### SUMMARY OF THE INVENTION

It is therefore one object of the invention to provide a hat unit comprising a crown including a pocket on one side, a visor, and an adjuster; a light assembly disposed on the hat unit; and a power supply device removably disposed in the pocket and comprising a rechargeable battery and a control assembly including a push button switch, a slide switch operable to switch the power supply device to a flashlight mode or an illumination mode, and a light emitting member, wherein in the flashlight mode, a first pressing of the push button switch enables the light emitting member to electrically connect to the battery for light emission, and a second pressing of the push button switch enables the light emitting member to electrically disconnect from the battery; and wherein in the illumination mode, the light assembly is electrically connected to the battery such that a pressing of the push button switch causes the light assembly to emit light, blink, or turn off.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of the lighted hat according to the invention;

FIG. 2 is a functional block diagram of the lighted hat of the invention;

FIG. 3 is a circuit diagram of the power supply device shown in FIG. 1;

FIG. 4 is an exploded view of the power supply device shown in FIG. 1;

FIG. 5 is an environmental view of the lighted hat of the invention being worn on a head of a wearer;

FIG. 6 is a perspective view of the power supply device shown in FIG. 1; and

FIG. 7 is a perspective view of the power supply device shown in FIG. 1 being charged by an adapter connected to a wall outlet.

### DETAILED DESCRIPTION OF THE INVENTION

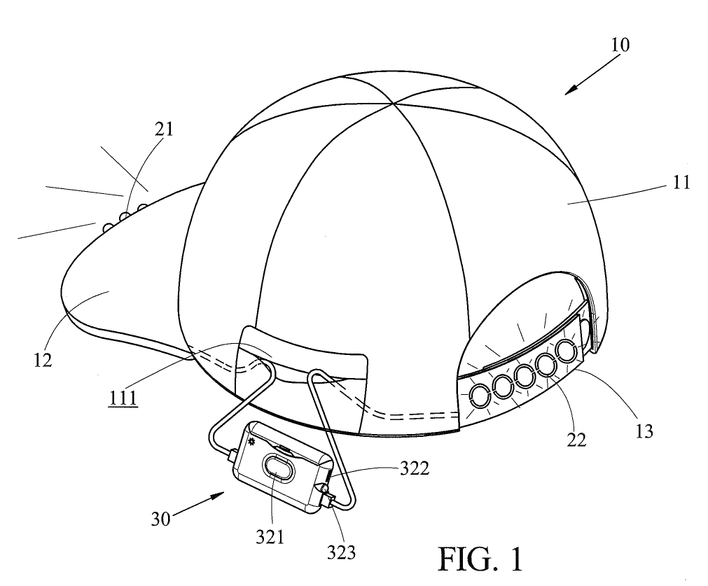

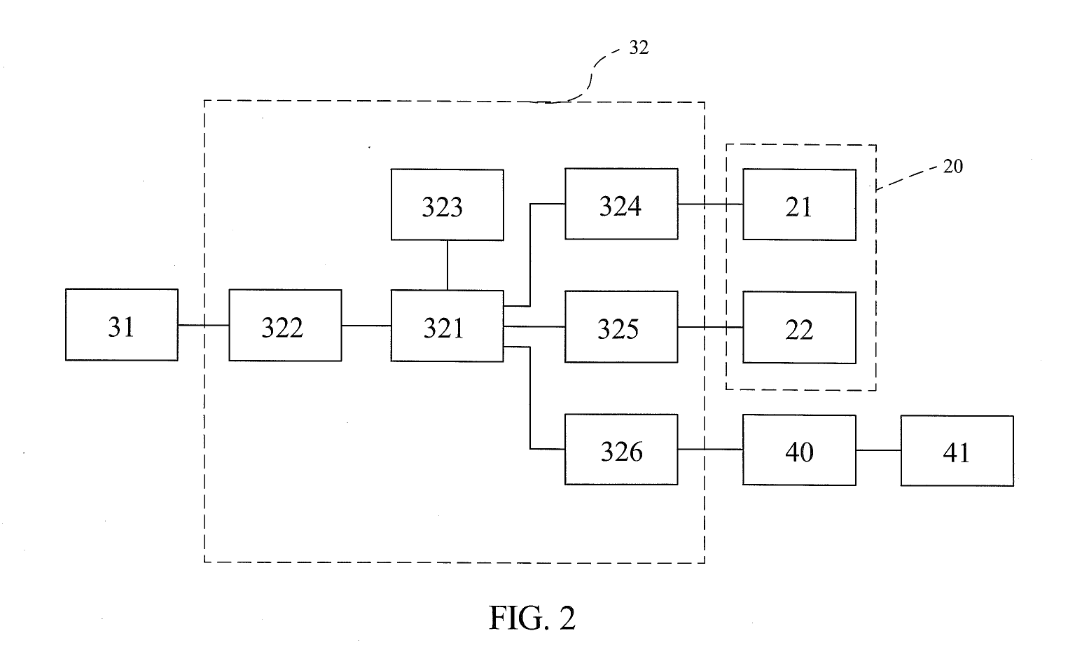

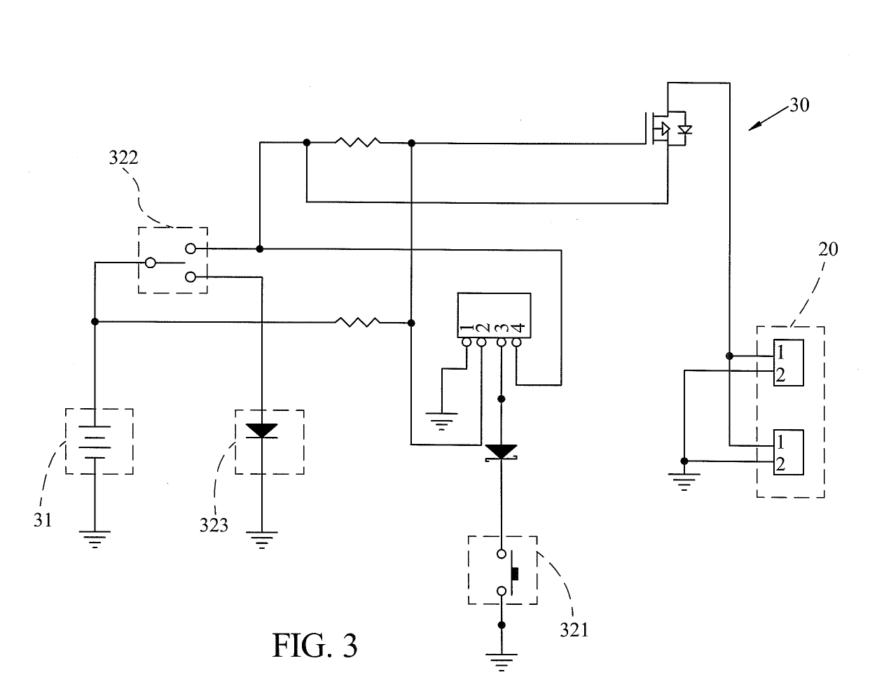

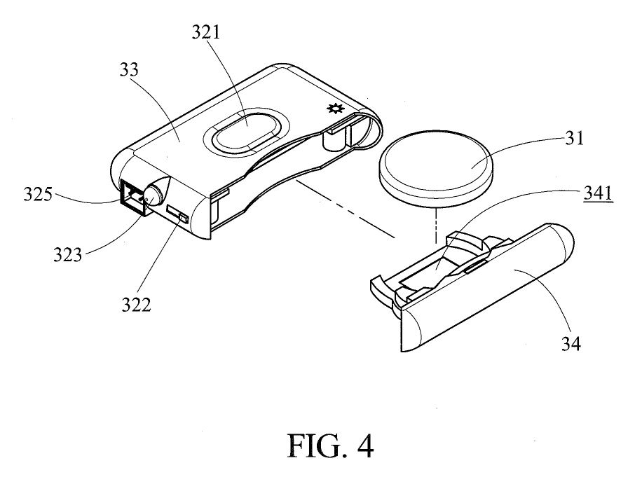

Referring to FIGS. 1 to 7, a lighted hat in accordance with a preferred embodiment of the invention comprises the following components as discussed in detail below.

A hat unit 10, shaped as a baseball cap, comprises a crown 11 including a pocket 111 on the left side, a visor 12, and an adjuster 13.

A light assembly 20 comprises front light emitters 21 provided on a front edge of the visor 12, and rear light emitters 22 provided on the adjuster 13. Each of the front and rear light emitters 21, 22 can be an LED (light-emitting diode) in this embodiment or a flexible light emitting element formed of fiber optic in other embodiments.

A rectangular power supply device 30 is removably provided in the pocket 111 and comprises a housing 33, a disc-shaped rechargeable battery 31, and a control assembly 32 including a push button switch 321 on one surface of the housing 33, a slide switch 322 on a front end of the housing 33, a light emitting member 323 on the front end of the housing 33 adjacent to the slide switch 322, a rear socket 324 electrically connected to the front light emitters 21 by a wire (not numbered), a front socket 325 adjacent to the light emitting member 323 and electrically connected to the rear light emitters 22 by another wire (not numbered), and a rear charging socket 326 adjacent to the rear socket 324.

The power supply device 30 further comprises a battery unit 34 removably provided at one open side of the housing 33 by snapping and including a battery compartment 341 with the battery 31 provided therein. A complete power supply device 30 is formed when the housing 33 and the battery unit 34 are assembled. Further, the battery 31 is electrically connected to the control assembly 32.

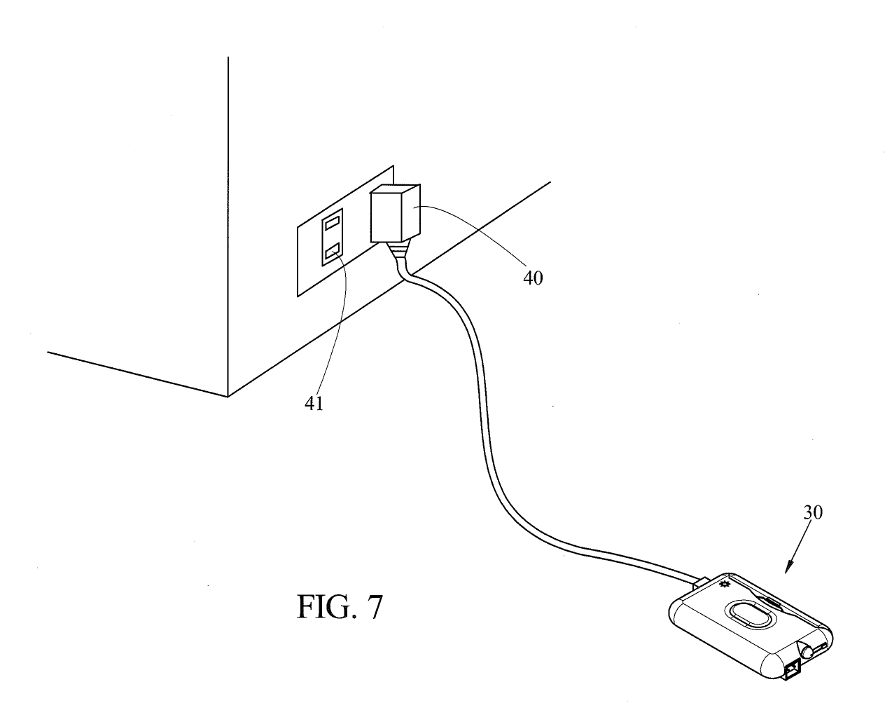

For charging the battery 31, an adapter 40 can be employed to insert into a wall outlet 41. A wire (not numbered) extending out of the adapter 40 has its end connector inserted into the rear charging socket 326. The adapter 40 has an input of AC 110V and an output of DC 3V-50 mA in this embodiment (see FIG. 7).

A user may slide the slide switch 322 to switch the power supply device 30 to a flashlight mode or an illumination mode. In the flashlight mode, a pressing of the push button switch 321 will cause the light emitting member 323 to electrically connect to the battery 31 for light emission, and a next pressing of the push button switch 321 will cause the light emitting member 323 to electrically disconnect to the battery 31. In the illumination mode, a pressing of the push button switch 321 will cause the light assembly 20 (i.e., both the front light emitters 21 and the rear light emitters 22) to emit light, blink, or turn off. In detail, a first pressing of the push button switch 321 will cause the light assembly 20 to emit light, a second pressing of the push button switch 321 will cause the light assembly 20 to blink, and a third pressing of the push button switch 321 will cause the light assembly 20 to turn off.

Preferably, the battery is a lithium battery.

Preferably, the light emitting member 323 is an LED.

Preferably, the hat unit 10 is a helmet.

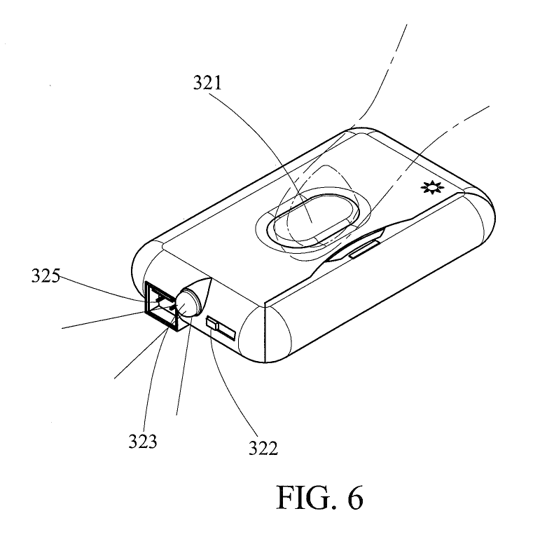

In use, a person may remove the power supply device 30 out of the pocket 111. Next, the person may slide the slide switch 322 to switch the power supply device 30 to the flashlight mode. Next, the person may press the push button switch 321 to activate the light emitting member 323 to emit light (see FIG. 6).

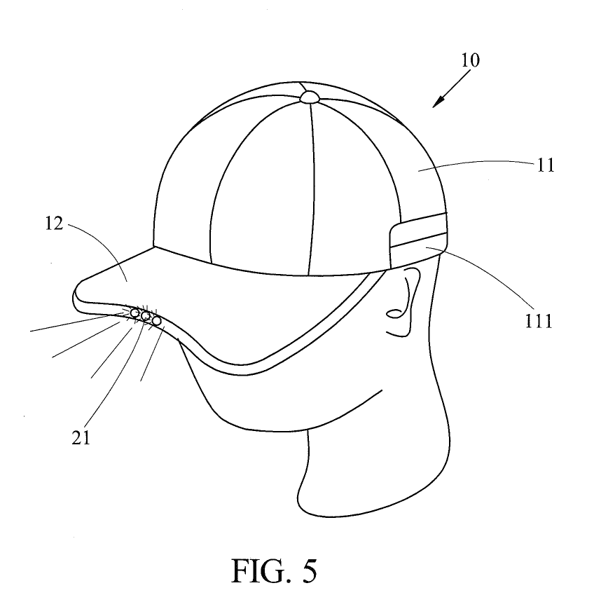

Alternatively, a person may slide the slide switch 322 to switch the power supply device 30 to the illumination mode. Next, the person may place the power supply device 30 in the pocket 111 and connect the power supply device 30 to the front light emitters 21 and the rear light emitters 22 respectively. Next, the person may wear the hat unit 10. Next, the person may press the push button switch 321 to cause the front light emitters 21 to emit light along with the person's front side, and cause the rear light emitters 22 to emit light rearward to illuminate his or her back and the adjacent area as a warning to vehicles approaching from the rear (see FIG. 5). In this mode, the person can free his or her hands for the performance of various tasks.

The invention has the following advantages. A person may operate the power supply device 30 as a flashlight. Alternatively, the person may wear the lighted hat for illumination while walking or working. Further, the battery of the lighted hat can be recharged if it is discharged by a typical adapter.

While the invention herein disclosed has been described by means of specific embodiments, numerous modifications and variations could be made thereto by those skilled in the art without departing from the scope and spirit of the invention set forth in the claims.

What is claimed is:

1. A lighted hat comprising:
a hat unit comprising a crown including a pocket on one side, a visor, and an adjuster;
a light assembly disposed on the hat unit; and
a power supply device removably disposed in the pocket and comprising a rechargeable battery and a control assembly including a push button switch, a slide switch operable to switch the power supply device to a flashlight mode or an illumination mode, and a light emitting member,
wherein in the flashlight mode, a first pressing of the push button switch causes the light emitting member to electrically connect to the battery for light emission, and a second pressing of the push button switch causes the light emitting member to electrically disconnect from the battery; and
wherein in the illumination mode, the light assembly is electrically connected to the battery such that a pressing of the push button switch causes the light assembly to emit light, blink, or turn off.

2. The lighted hat of claim 1, wherein the light assembly comprises at least one front light emitter mounted on a front edge of the visor, and at least one rear light emitter mounted on the adjuster.

3. The lighted hat of claim 2, wherein the at least one front light emitter comprises a plurality of LEDs (light-emitting diodes), and the at least one rear light emitter comprises a plurality of LEDs.

4. The lighted hat of claim 2, wherein the at least one front light emitter comprises a flexible light emitting element formed of fiber optic, and the at least one rear light emitter comprises a flexible light emitting element formed of fiber optic.

5. The lighted hat of claim 2, wherein the control assembly further comprises a rear socket electrically connected to the at least one front light emitter, and a front socket electrically connected to the at least one rear light emitter.

6. The lighted hat of claim 1, wherein the control assembly further comprises a charging socket for charging the battery.

7. The lighted hat of claim 1, wherein the power supply device further comprises a housing having an open side, and a battery compartment with the battery held therein, the battery compartment being assembled at the open side of the housing so as to electrically connect the control assembly to the battery.

8. The lighted hat of claim 1, wherein the battery is a lithium battery.

9. The lighted hat of claim 1, wherein the light emitting member is an LED.

10. The lighted hat of claim 1, wherein the hat unit is a helmet.
